(19) United States
(12) Patent Application Publication
(10) Pub. No.: US 2016/0071082 A1
(43) Pub. Date: Mar. 10, 2016

(54) AUTOMATED SPLITTING OF COSTS INCURRED DURING A SHARED VEHICLE TRAVEL

(71) Applicant: EBAY INC., San Jose, CA (US)

(72) Inventors: Dennis Driscoll, Chalfont, PA (US); Michael Charles Todasco, Santa Clara, CA (US)

(21) Appl. No.: 14/479,234

(22) Filed: Sep. 5, 2014

(51) Int. Cl. G06Q 20/22; G07B 15/02

(52) U.S. Cl. CPC G06Q 20/22; G07B 15/02

(57) ABSTRACT

There are provided systems and methods for automated splitting of costs incurred during a shared vehicle travel. A plurality of users may utilize a vehicle to travel a route, such as a ride sharing program between the plurality of users. The vehicle may incur various costs during travel of the route, such as fuel/electric consumption, tolls, maintenance fees, or other costs. Each of the plurality of users may be checked in to the vehicle, such as by submitting log in credentials to a device associated with the vehicle or connecting their user device to the vehicle's device. Once inside the vehicle, parameters for the user may be determined, including weight of the user and the user's luggage and a start and endpoint of the user's use of the vehicle. The user may then be billed their pro rata share of the total costs for use of the vehicle.

### TECHNICAL FIELD

The present application generally relates to automated splitting of costs incurred during a shared vehicle travel and more specifically to determining each user's pro rata share of travel costs based on the user's parameters and travel costs incurred during a vehicle's travel.

### BACKGROUND

Vehicle systems may be able to track mileage and fuel consumption during travel and determine various costs associated with a trip. This may assist users in trip planning and managing expenses. Additionally, to reduce costs, users may elect to share rides to certain locations, for example, work car pools that assign each traveler one or more week days to drive their co-workers. However, when travelling, additional costs may be incurred by the driver that are less easily detected and/or managed, such as vehicle maintenance costs and weight differentiation between travelers and their luggage. Moreover, certain costs may not be added, such as tolls incurred for certain routes. Thus, determination of actual costs incurred by each traveler may be inaccurate and not reflect true usage of the vehicle by the traveler. Additionally, the owner of the vehicle may be required to calculate each traveler's costs and then bill each traveler, which may be time consuming and a hassle to receive payment.

### BRIEF DESCRIPTION OF THE DRAWINGS

FIG. 1 is a block diagram of a networked system suitable for implementing the processes described herein, according to an embodiment;

FIG. 2 is an exemplary environment showing users checked-in to a vehicle for splitting of travel costs, according to an embodiment;

FIG. 3 is an exemplary system environment showing a vehicle system calculating travel costs owed by each travel in a vehicle, according to an embodiment;

FIG. 4 is a flowchart of an exemplary process for automated splitting of costs incurred during a shared vehicle travel, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide automated splitting of costs incurred during a shared vehicle travel. Systems suitable for practicing methods of the present disclosure are also provided.

A plurality of users may utilize a vehicle to travel a route or part of a route together. For example, users may engage in ride sharing to a location, such as work, or may arrange a trip together with friends, or users may be picked up or dropped off along various locations along a route. When getting in to the vehicle, each of the users may check-in to the vehicle by providing some information to a device associated with the vehicle. The user may check-in by providing a log in credential to a user account for the user, for example, a name and PIN/password associated with the user account. The user may also check-in to the vehicle's device by connecting to the vehicle's device using a user device of the user. In such embodiments, the user may have a mobile/smart phone, wearable computing device (e.g., eyeglasses or wristwatch with processing features), tablet computer, or other user device. The device for the vehicle may correspond to a dashboard or other onboard computing device, or may correspond to a device associated with an owner, driver, or primary user of the vehicle, such a mobile/smart phone, tablet computer, wearable computing device, or other user device. The device in the vehicle may provide short range wireless communications with the user device for each user in the vehicle, such as through Bluetooth Low Energy (BLE), LTE Direct, WiFi, near field, or other communication protocols. Once the vehicle's device and each of the plurality of user's devices connect, each of the plurality of users may be checked-in to the vehicle. By checking in to the vehicle, the vehicle's device may be provided with check-in information, such as an identifier, a user account, or other identification information for the user. In various embodiments, the user may also check in using biometrics, such as a fingerprint scanner, a retinal scan, a breathalyzer, and/or other biometric (including DNA analysis).

Each user may voluntarily choose to check-in to the vehicle's device through their user device or by providing log in credentials to the vehicle's device, as previously discussed. Additionally, the vehicle's device may also request each of the plurality of users to check-in based on detecting the users in the vehicle. The device may determine each of the plurality of users is in the vehicle based on detecting their user devices in proximity to the vehicle, as previously discussed. In other embodiments, the device may detect the users are in the vehicle based on weight sensors in the vehicle, for example, in a floor mat or seat. The vehicle may also determine the users are in the vehicle using a door sensor and/or a camera in the vehicle. The aforementioned biometrics may also be utilized to determine a user is in the vehicle. Once a user is detected to be located in the vehicle, the vehicle's device may request that the user log-in and/or provide check-in information to the device.

Once a user is checked-in to the vehicle, parameters for the user may be determined. The user's parameters may include a weight for the user, a start point to the user's travel in the vehicle, an end point to the user's travel in the vehicle, a weight for the user's luggage in the vehicle, and/or a deviation from an ideal route between endpoints caused by picking up the user in the vehicle (e.g., the amount of travel from exiting and re-entering a freeway to pick up a user at their pickup location). The parameters of the user may be determined from the vehicle's device using the vehicle's sensors and stored with the check-in information. In other embodiments, the check-in information may include the parameters, such as a weight and/or address in a user profile for a user account of the user.

The vehicle's device may also track costs incurred by the vehicle and the users in the vehicle while travelling the route. The costs may include fuel and/or electrical consumption of the vehicle while in use, rental car fees or fees associated with utilizing a non-owned vehicle by the driver (e.g., car services, shared car services, etc.), tolls incurred during travel by the users, maintenance of the vehicle (e.g., oil change costs, tire replacement, car servicing, other wear and tear including car washes, etc.), specialty driving requirement (e.g., snow chains, high temperature fluid requirements, etc.), and/or payments made through the vehicle's device (e.g., for food/drink purchased through the vehicle's device, wireless internet usage, On-Star® usage, etc.). The costs may also include insurance costs for use of the vehicle, including an overall insurance plan (e.g., a monthly or yearly fee), a rental insurance fee (e.g., a flat or daily insurance fee), and/or a per mileage insurance fee. The costs may also correspond to all user's costs. The costs may also be incurred by an individual user's usage of the vehicle, for example, if a toll road is required to pick up an individual user.

Using the user's parameters and the costs associated with the use of the vehicle, each of the plurality of users' pro rata share/portion of the total costs may be determined. The pro rata share may be determined by the user's individual responsibility of the total costs based on their parameters, such as weight, their starting/ending point, and the deviation from the ideal route caused by the user. The pro rata share may also include the user's individual responsibility for costs incurred solely due to the individual user, for example, the aforementioned toll caused by one user. Once the pro rata share of the total costs is determined for each of the plurality of users, each of the plurality of users' pro rata portion may be communicated to the users. The pro rata share for each of the plurality of users may be displayed on the device associated with the vehicle and/or communicated to user devices for each of the plurality of users (e.g., using the check-in information). Additionally, a payment provider that may provide payment services for each of the plurality of users' pro rata share, for example, after receiving the pro rata shares or calculating the pro rata shares. Thus, the vehicle's device and/or the payment provider may provide processing services to determine the pro rata shares.

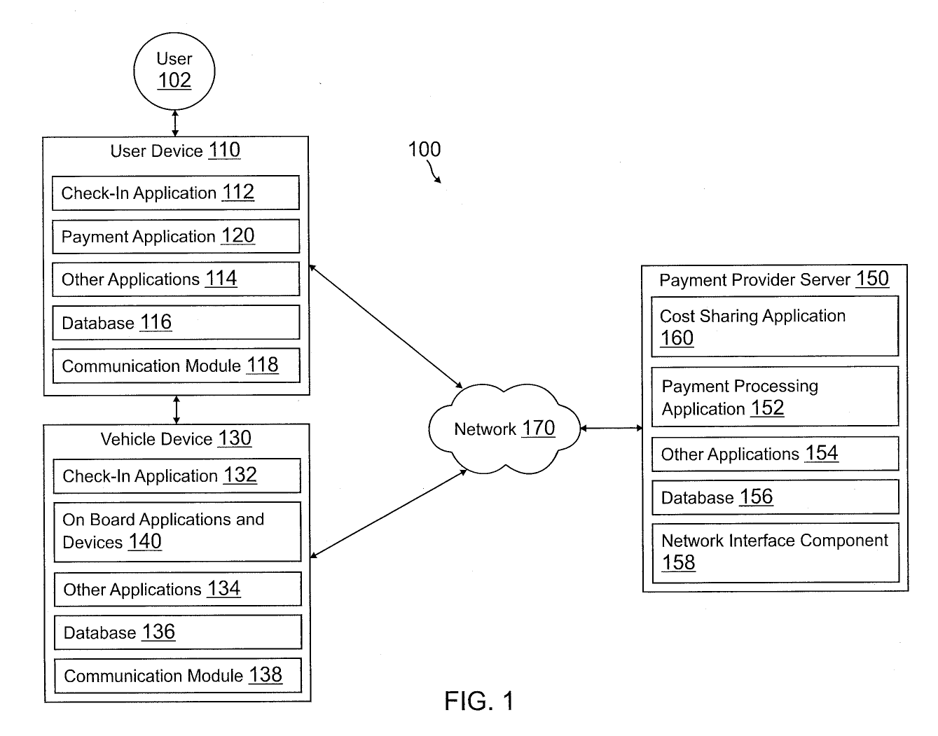

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a vehicle device 130, and payment provider server 150 in communication over a network 170. User 102, such as a traveler in a vehicle corresponding to vehicle device 130, may utilize user device 110 to check-in to the vehicle through vehicle device 130. In other embodiments, user 102 may provide check-in information directly to vehicle device 130. Vehicle device 130 may then track parameters for user 102 and trip costs. Payment provider server 150 may determine a pro rata share of the trip costs for user 102 using the parameters and the total trip costs. In other embodiments, vehicle device 130 may determine the pro rata share. User 102 may then utilize user device 110 to process a payment for user 102's pro rata share, for example, using payment provider server 150.

User device 110, vehicle device 130, and payment provider server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

User device 110 may be implemented using any appropriate hardware and software configured for wired and/or wireless communication with vehicle device 130 and/or payment provider server 150. For example, in one embodiment, user device 110 may be implemented as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may function similarly.

User device 110 of FIG. 1 contains a check-in application 112, a payment application 120, other applications 114, a database 116, and a communication module 118. Check-in application 112, payment application 120, and other applications 114 may correspond to processes, procedures, and/or applications, for example, a software program, executable by a hardware processor. In other embodiments, user device 110 may include additional or different software as required.

Check-in application 112 may be used by user 102 of user device 110 to establish a connection with vehicle device 130, including a check-in with a vehicle corresponding to vehicle device 130. Check-in application 112 may correspond to a specific application utilized by user device 110 with vehicle device 130 to complete a check-in for the vehicle. The check-in with vehicle device 130 may correspond to a process to log in to a user account of user 102 with vehicle device 130 (or payment provider server 150 if payment provider server 150 provides check-in services). For example, check-in application 112 may provide account credentials, such as an account name, password, and/or PIN that verifies the identity of user 102. In other embodiments, the check-in may provide and/or verify the identity of user 102, including transmission of an identifier for user 102 and/or user device 110. The check-in may be completed over network 170 with vehicle device 130. In such embodiments, check-in application 112 may correspond more generally to a browser application configured to communicate with vehicle device 130.

Check-in application 112 may also receive short range wireless communications from vehicle device 130 when in proximity to and/or located within a vehicle corresponding to vehicle device 130. Check-in application 112 may transmit information to vehicle device 130 when receiving the short range wireless communications, including check-in information for a check-in process with vehicle device 130. Vehicle device 130 may be set to be range limited to the vehicle. Thus, check-in application 112 may transmit information to vehicle device 130 when user 102 is nearby the vehicle, enabling vehicle device 130 to determine that user 102 is nearby/within the vehicle, as will be explained in more detail herein.

Check-in application 112 may execute in the background of an operating system of user device 110 and be configured to establish connections, using communication module 118 of user device 110, with vehicle device 130. The connection may be established with or without user input from user 102. For example, vehicle device 130 may broadcast a token, such as a universally unique identifier (UUID), for reception by check-in application 112, as will be explained in more detail herein. Check-in application 112 may utilize communication module 118 of user device 110 to receive the token from vehicle device 130. If check-in application 112 acknowledges the UUID as identifying vehicle device 130 and/or payment provider server 150 (e.g., if check-in application 112 determines the UUID corresponds to a request to complete a check-in), check-in application 112 may transmit an identifier corresponding to user 102 and/or user device 110 back to vehicle device 130. Check-in application 112 may utilize communication module 118 of user device 110 to communicate with vehicle device 130 (e.g., over near field communication, Bluetooth, Bluetooth Low Energy, radio, infrared, LTE Direct, or other connection). The identifier from user device 110 may include, be transmitted with, concatenated with, or otherwise bundled with the identifier received from vehicle device 130. In other embodiments, different information may be transmitted to vehicle device 130, such as a name or other personal information for user 102, a user account for user 102 with vehicle device 130 or payment provider server 160, log in information for user 102 with vehicle device 130, and/or other identification information. Thus, the information transmitted to vehicle device 130 does not need to be utilized to process and/or complete a check-in with vehicle device 130 in all embodiments.

Once a connection is established with vehicle device 130, user device 110 may be checked-in with vehicle device 130 if user 102 has not previously been checked-in. The check-in process may then associate user 102 with the vehicle corresponding to vehicle device 130. Once user 102 is checked-in to the vehicle, vehicle device 130 may determine parameters associated with user 102 and track travel costs associated with user 102's use of the vehicle. Check-in application may provide the parameters to vehicle device 130, for example, a weight for user 102 and/or user 102's luggage, a start location for user 102 in a route, and/or an end location for user 102 in the route. In this manner, a pro rata share/portion of travel costs may be determined for user 102. In other embodiments, user 102 may provide check-in information and/or log in information directly to vehicle device 130, for example, using an input device/interface of vehicle device 130, as will be explained in more detail herein.

Payment application 120 may be used, for example, to provide a convenient interface to permit user 102 to select payment options and provide payment for a pro rata share of travel costs. For example, payment application 120 may be implemented as an application having a user interface enabling the user to enter payment options for storage by user device 110, provide payment to a user/entity owning or operating the vehicle associated with vehicle device 130, and complete a transaction for the pro rata share of travel costs using, in various embodiments, payment provider server 150. In certain embodiments, payment application 120 may correspond more generally to a web browser configured to view information available over the Internet or access a website corresponding to a payment provider.

Payment application 120 may be configured to provide payment to the user/entity owning or operating the vehicle corresponding to vehicle device 130 (e.g., an owner of the vehicle, a rental company owning the vehicle, a driver operating the vehicle, etc.). In this regard, payment application 120 may correspond to an application that may provide an interface where user 102 may view a received pro rata share of travel costs from use of the vehicle. Thus, user device 110 may receive the pro rata share from vehicle device 130 and/or payment provider server 150 after calculation of the pro rata share, as will be discussed in more detail herein. Additionally, user 102 may generate a payment request for the pro rata share. The payment request may instruct payment provider server 150 to provide payment for the owner/operator of the vehicle. Additionally, the payment request may denote a payment instrument that payment provider server 150 may utilize to provide the payment to the owner/operator. Payment application 120 may correspond to a dedicated application for payment provider server 150 (e.g., a specific device application) or may correspond to a browser application. In other embodiments, payment application 120 may utilize another payment instrument, such as a credit/debit card, a bank account, etc.

The payment request may correspond to a token including the selected payment instrument for user 102. The payment instrument may include an account identifier, payment card, bank account, etc. Once the payment request is generated, user 102 may authorize the payment request for transmission to payment provider server 150 in order to effectuate a payment to the owner/operator. User device 110 may transmit the payment request to payment provider server 150 with an identifier for the owner/operator of the vehicle in order to complete the payment. In other embodiments, payment application 120 may transmit the payment request as a token with a payment instrument and identifier for user 102 to vehicle device 130 for completion by the owner/operator of the vehicle corresponding to vehicle device 130.

In various embodiments, one or more features of check-in application 112 and/or payment application 120 may be incorporated in the same application so as to provide their respective features in one application.

User device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, or other applications associated with payment provider server 150. Other applications 114 may include browser, social networking, and/or mapping applications. The aforementioned applications may also be used in conjunction with check-in application 112 and/or payment application 120. Other applications 114 may contain software programs, executable by a processor, including a graphical user interface (GUI) configured to provide an interface to the user.

User device 110 may further include database 116 which may include, for example, identifiers such as operating system registry entries, cookies associated with check-in application 112, payment application 120, and/or other applications 114, identifiers associated with hardware of user device 110, or other appropriate identifiers, such as identifiers used for payment/user/device authentication or identification. Identifiers in database 116 may be used by a payment/credit provider, such as payment provider server 150, to associate user device 110 with a particular account maintained by the payment/credit provider. Database 116 may include user device tokens and/or encryption keys, including an encryption key of vehicle device 130 and/or payment provider server 150 for use in identifying a check-in request. Thus, database 116 may include identifying information for tokens enabling check-in application 112 to identify vehicle device 130 and/or payment provider server 150 when receiving a corresponding check-in token. Database 116 may also store parameter information for user 102, such as map directions and/or coordinates for use in determining start and end locations for user 102 and/or user 102 weight, luggage weight, or other characteristic. Where user device 110 receives the pro rata share of travel costs from use of the vehicle associated with vehicle device 130, database 116 may store such information, generated payment requests, and/or transaction histories for such payment requests.

User device 110 includes at least one communication module 118 adapted to communicate with vehicle device 130 and/or payment provider server 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with vehicle device 130 using short range communications, such as Bluetooth Low Energy, LTE Direct, radio frequency, infrared, Bluetooth, and near field communications.

Vehicle device 130 may be implemented using any appropriate hardware and software configured for wired and/or wireless communication with user device 110 and/or payment provider server 150. In various embodiments, vehicle device 130 may be implemented as a device for an owner/operator of a vehicle corresponding to vehicle device 130, such as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®, which may provide processing services for the vehicle. Vehicle device 130 may also be implemented as a device physically attached to and/or connected to the vehicle, such as a dashboard or central console computing system, a heads up display with attached processing devices, and/or a similar in vehicle on board computing system. Although a vehicle device is shown, the vehicle device may be managed or controlled by any suitable processing device. Although only one vehicle device is shown, a plurality of vehicle devices may function similarly. Moreover, in various embodiments, one or more of the applications, processes, and/or features discussed below in reference to vehicle device 130 may be included in payment provider server 150, and vice versa. For example, the processes and features of a cost sharing application 160 of payment provider server 150 may be implemented on vehicle device 130 instead.

Vehicle device 130 of FIG. 1 contains a check-in application 132, on board applications and devices 140, other applications 134, a database 136, and a communication module 138. Check-in application 132, on board applications 140, and other applications 134 may correspond to processes, procedures, and/or applications, for example, a software program, executable by a hardware processor. In other embodiments, vehicle device 130 may include additional or different software as required.

As previously discussed, vehicle device 130 may be located in, attached and connected to, and/or associated with a vehicle. User device 110 may connect to vehicle device 130 in order to provide information to vehicle device 130 to effectuate a check-in that associates user 102 with the vehicle (e.g., travelling in the vehicle). Thus, check-in application 132 may correspond to an application for transmitting requests to establish a connection between a device (e.g., user device 110) and vehicle device 130. The requests may be unique to vehicle device 130, the vehicle corresponding to vehicle device 130, and/or check-in application 132, thereby identifying the vehicle in the request. Thus, check-in application 132 may utilize short range wireless communications of vehicle device 130 to transmit the requests to establish a connection, including an identifier such as a Universally Unique Identifier (UUID). If user device 110 receives a request to establish the connection with vehicle device 130 and responds with an identifier for user 102/user device 110 (potentially including the UUID and other information necessary to effectuate a check-in for user 102), check-in application 132 may cause vehicle device 130 to ramp up in power and create a connection between user device 110 and vehicle device 130.

Check-in application 132 may uniquely transmit the request to establish the connection with vehicle device 130 as a short range wireless communication (e.g. a BLE protocol communication) including a “wake up” process for check-in application 112 of user device 110 and/or a token for vehicle device 130 transmitting the request. In other embodiments, the request and/or connection may utilize near field communication, radio communication, infrared communication, or Bluetooth communication. Additionally, although vehicle device 130 may utilize BLE protocol communications to effectuate an “always on” type service where the UUID and “wake up” process are transmitted continuously by check-in application 132, other communication protocols used to provide an “always on” service may include QUALCOMM® LTE Direct or similar device-to-device communication technology. BLE and LTE Direct may both be utilized to provide discovery of nearby devices to vehicle device 130 (e.g., user device 110) and establishment of a connection for data transfers.

The request may be specific to user device 110 by including information that is specific to user 102, such as a name, identifier, account information, and/or user device identifier. The information specific to user 102 may be determined from a user account of user 102 or other information previously provided to vehicle device 130 and/or payment provider server 150. Thus, in certain embodiments, only user device 110 will pick up and authenticate the request. In other embodiments, user device 110 may only pick up the request based on the signal range and/or physical context for vehicle device 130 transmitting the request (e.g., located within the vehicle corresponding to vehicle device 130 and/or range limited to the vehicle).

After check-in application 132 receives an identifier from user device 110, check-in application 132 may determine user 102 is in proximity to the vehicle associated with vehicle device 130. Thus, check-in application may complete check-in with user device 110 for the vehicle. The check-in request may include log in information for a user account with vehicle device 130 and/or payment provider server 150 and thus complete the check-in with user 102 by verifying the account information. For example, the check-in information may include an identifier or other account information for a user/payment account of user 102. However, in embodiments where a user account has not been previously established by user 102, check-in application 132 may receive other information identifying user 102, including a user name/identifier, user device identifier, an identifier for an account with another server, or other information. The check-in information may include further information about user 102, such as user parameters for user 102 (e.g., weight, luggage weight, trip plans, necessary purchases and/or tolls, etc.).

In various embodiments, check-in application 132 may also request a check-in from user 102 directly, for example, using an input device associated with vehicle device 130. In such embodiments, user 102 may provide an identifier, user account name, password, and/or PIN directly to vehicle device 130 without the use of user device 110. Such information may be entered to check-in application 132 using an interactive touch screen, a keyboard, a mouse, or other input device for vehicle device 140. Check-in application 132 may then confirm that user 102 is located within the vehicle corresponding to vehicle device 130 and begin tracking parameters and travel costs for user 102. In certain embodiments, check-in of user 102 may be accomplished by check-in application 132 utilizing payment provider server 150, for example, to confirm user account credentials for an account for user 102 with payment provider server 150. In other embodiments, biometrics including retinal scans, fingerprint analysis, breathalyzer, and/or DNA analysis may also be utilized to check-in user 102 by check-in application 132.

Vehicle device 130 may further include on board applications and devices 140, which may include various vehicle sensors, devices, and processors with their corresponding applications. In this regard, on board applications and devices 140 may include devices and applications configured to determine costs incurred during operation of a vehicle corresponding to vehicle device 130 (e.g., when travelling a route). On board applications and devices 140 may include fuel sensors and gauges, electrical meters for determining electrical usage by the vehicle, odometers and other distance recording devices, weight sensors, tire sensors configured to detect tire wear and tear, oil level and usage sensors, and other maintenance sensors. Such sensors may be utilized to determine total costs incurred during use of a vehicle. The total costs may correspond to overall costs for usage of the vehicle during a specific route. The total costs determined using on board applications and devices 140 may include fuel/electrical usage, oil usage, tire usage, maintenance, and other wear and tear for usage of the vehicle. Total costs may also include costs associated with use of on board applications and devices 140, such as usage of mobile/satellite communication features, wireless Internet usage, and/or driving services, such as OnStar®. In various embodiments, on board applications and devices 140 may also include payment mechanisms or mapping mechanism (e.g., a GPS unit) configured to determine tolls paid during use of the vehicle in the route. On board applications and devices 140 may also include payment applications, for example, one offered by PAYPAL®, Inc. of San Jose, Calif. Such applications may be configured to make payments during use of the vehicle, including payments for services (e.g., car washes, oil changes, etc.), food/drink purchased (e.g., through a drive through), fuel purchases, etc. On board applications and devices 140 may also track insurance costs for use of the vehicle, including an overall insurance plan (e.g., a monthly or yearly fee), a rental insurance fee (e.g., a flat or daily insurance fee), and/or a per mileage insurance fee. However, in other embodiments, any of the aforementioned information may be provided to payment provider server 150 for processing by an owner/operator of the vehicle. Thus, on board applications and devices 140 may not track such costs in all embodiments.

On board applications and devices 140 may also include devices and applications that may be configured to detect if one or more users are in the vehicle, and parameters for those users in the vehicle. In this regard, on board applications and devices 140 may include seat weight sensors, floor mat weight sensors, door sensors, and/or an interior camera configured to detect if a person (e.g., user 102) has entered and is located inside the vehicle corresponding to vehicle device 130. Once user 102 has been detected to be inside the vehicle, on board applications and devices 140 may request a check-in for user 102. The check-in may be requested using check-in application 132 and may be completed using user device 110 or an input device of vehicle device 130 (e.g., a touch screen, keyboard, mouse, or other input device). Once checked-in to vehicle device 130, on board applications and devices 140 may detect parameters for user 102. Such parameters may correspond to a start point during a travel route, an end point during the travel route, a weight for user 102 (e.g., using a weight sensor in a seat or floor mat), a weight for luggage of user 102 (e.g., using a weight sensor in a trunk of the vehicle), or other parameters. On board applications and devices 140 may then transmit parameters for user 102 and travel costs for use of the vehicle to payment provider server 150 for processing. As previously discussed, in various embodiments, vehicle device 130 may process the aforementioned information to determine a pro rata share of the travel costs incurred by user 102's use of the vehicle.

Vehicle device 130 includes other applications 134 as may be desired in particular embodiments to provide features to vehicle device 130. For example, other applications 134 may include security applications for implementing client-side security features, programmatic client applications for interfacing with appropriate application programming interfaces (APIs) over network 170, or other types of applications. Other applications 134 may also include email, texting, voice and IM applications that allow an owner/operator of a vehicle corresponding to vehicle device 130 to send and receive emails, calls, texts, and other notifications through network 170. Such communication applications may also correspond to mobile, satellite, wireless Internet, and/or radio communication applications connected to car services, such as OnStar®. In various embodiments, other applications 134 may include financial applications, such as banking, online payments, money transfer, or other applications associated with payment provider server 150 that may be utilized to perform payments while in the vehicle, such as tolls, food/drink purchase, fuel purchase, etc. Other applications 134 may be utilized to determine costs accrued during use of the vehicle by user 102 and other users. Other applications 134 may contain other software programs, executable by a processor, including a graphical user interface (GUI) configured to provide an interface for vehicle device 130 to the user.

Vehicle device 130 may further include database 136 which may include, for example, identifiers such as operating system registry entries, cookies associated with check-in application 132 and/or other applications 134, identifiers associated with hardware of vehicle device 130, or other appropriate identifiers, such as identifiers used for payment/user/device authentication or identification. In one embodiment, identifiers in database 136 may be used by payment provider server 150 to associate vehicle device 130 with a particular account maintained by payment provider server 150. Database 136 may also store user 102's information, including check-in information, an identifier, etc., for user 102. Database 136 may also include parameters determined and/or received for user 102. Costs accrued during use of the vehicle corresponding to vehicle device 130 may be stored by database 136.

Vehicle device 130 includes at least one communication module 138 adapted to communicate with user device 110 and/or payment provider server 150. In various embodiments, communication module 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 138 may communicate directly with user device 110 using short range communications, such as Bluetooth Low Energy, LTE Direct, radio frequency, infrared, Bluetooth, and near field communications.

Payment provider server 150 may be maintained, for example, by an online payment service provider, which may provide payment services and/or processing for financial transactions on behalf of a user. In this regard, payment provider server 150 includes one or more processing applications which may be configured to interact with user device 110 and/or vehicle device 130 to determine pro rata shares of travel costs incurred during use of a vehicle and facilitate payment for the pro rata shares. In one example, payment provider server 150 may be provided by PAYPAL®, Inc. of San Jose, Calif., USA. However, in other embodiments, payment provider server 150 may be maintained by or include a credit provider, financial services provider, financial data provider, and/or other service provider, which may provide payment services to user 102 and/or the owner/operator of the vehicle corresponding to vehicle device 130. Moreover, in various embodiments, one or more of the applications, processes, and/or features discussed below in reference to payment provider server 150 may be included in vehicle device 130, and vice versa.

Payment provider server 150 of FIG. 1 includes a cost sharing application 160, a payment processing application 152, other applications 154, a database 156, and a network interface component 158. Cost sharing application 160, payment processing application 152, and other applications 154 may correspond to processes, procedures, and/or applications executable by a hardware processor, for example, a software program. In other embodiments, payment provider server 150 may include additional or different software as required, such as a check-in application as discussed in reference to vehicle device 130, where those features are instead provided by payment provider server 150. Additionally, vehicle device 130 may include processing features provided by payment provider server 150, such as cost sharing application 160, in various embodiments.

Cost sharing application 160 may include features, processes, and/or procedures to determine a pro rata share of travel costs incurred by user 102's use of a vehicle associated with vehicle device 130, for example, when travelling a route in the vehicle. In this regard, payment provider server 150 may receive information from user device 110 and/or vehicle device 130 corresponding to parameters for user 102, such as a map, itinerary, and/or check-in information detailing a start point and an end point for user 102 while travelling in the vehicle, tolls caused by user 102's use of the vehicle (e.g., as shown in the map), deviations from an ideal route caused by user 102's use of the vehicle, a weight for user 102, and/or a weight for luggage of user 102 in the vehicle. In certain embodiments, the parameters may also be stored with payment provider server 150, such as in database 156 of payment provider server 150. Payment provider server 150 may also receive travel costs incurred during use of the vehicle corresponding to vehicle device 130, for example, fuel/electrical consumption, maintenance, wear and tear, tolls, and/or payment issued by vehicle device 130. As previously discussed, vehicle device 130 may track such travel costs. Additionally, an owner/operator of the vehicle may track such travel costs and submit the travel costs to payment provider server 150.

Once payment provider server 150 has received parameters for user 102 and travel costs for use of the vehicle associated with vehicle device 130, cost sharing application 160 may determine a pro rata share/portion of the travel costs caused by user 102's use of the vehicle. For example, the vehicle may travel between point A and point B, where user 102 may be picked up at point A and dropped off at point B with the other users in the vehicle (e.g., the owner/operator and/or passengers). Additionally, user 102 may weigh 180 pounds and be carrying luggage weighing 20 pounds, while the driver and another passenger in the vehicle may each only contribute 150 pounds to the weight in the vehicle. While using the vehicle, X amount of fuel may be consumed, and a $5 toll for bridge use may be paid by the driver. Additionally, Y amount of maintenance may be required by the vehicle after the use, and all three passengers may have purchased food using a payment application with vehicle device 130. In such an example, user 102's pro rata share of the travel costs may incur ⅖ of the X amount of fuel (for weighing a total of 200 pounds compared to the 300 pounds for both the driver and the other passenger), ⅓ of the $5 toll and Y amount of maintenance costs (as there are 3 users incurring ⅓ of flat usage costs each), and user 102's portion of the purchased food. Thus, the pro rata share includes the amount of use of the vehicle that user 102 is responsible to pay.

In various embodiments, cost sharing application 160 may also determine the pro rata share based on where user 102 is picked up (e.g., after a starting point of a route) and dropped off (prior to an end to the route). Maintenance costs may also be allocated to user 102 in a greater or lesser amount than a flat shared fee, for example, if user 102 weighs more than the other passengers or if the route to pick up user 102 causes additional incurred maintenance due to wear and tear (e.g., difficult driving conditions to pick up user 102). Various other travel costs may also be attributable to user 102 and thus affect the pro rata share of the travel costs determined by cost sharing application 102, such tolls incurred just to pick up user 102 or utilizing a route due to picking up user 102, specialty driving requirements caused by user 102's use of the vehicle, vehicle rental costs incurred by additional use of the vehicle by user 102 (e.g., additional mileage used by user 102 in a rental car) and/or payment issued by vehicle device 130 for items/services requested by user 102 (e.g., wireless Internet usage, mobile phone usage, etc., using vehicle device 130). Moreover, certain costs may be shared evenly by all users in the vehicle in certain embodiments, such as daily vehicle rental costs, tolls incurred by usage of the route and not attributable to one user, etc. Once each users' pro rata share/portion of the costs incurred during use of a vehicle is determined by cost sharing application 160, cost sharing application 160 may communicate the pro rata shares to the user. For example, user 102 may view the pro rata share using user device 110 while an owner/operator of the vehicle may view pro rata shares using vehicle device 130. Payment processing application 152 may then be utilized by one or more users to complete a payment for their pro rata share.

Payment processing application 152 may be configured to receive information from and/or transmit information to user device 110 and/or vehicle device 130 for processing and completion of financial transactions. Payment processing application 152 may include one or more applications to process financial transaction information by receiving a payment request to complete transaction for a pro rata share of travel costs incurred during use of a vehicle corresponding to vehicle device 130. The payment request may correspond to a payment from user 102 to an owner/operator of the vehicle. The payment request may include a user account identifier or other payment information (e.g. a credit/debit card or checking account) for user 102 and a receiving account for the owner/operator. Additionally, the payment request may include a payment amount and terms of payment for the pro rata share. Payment processing application 152 may complete the transaction by providing payment to the owner/operator through the receiving account/payment information. Additionally, payment processing application 152 may provide transaction histories, including receipts, to user device 110 and/or vehicle device 130 for completion and documentation of the financial transaction. For example, a transaction history may be provided to user device 110 and/or vehicle device 130 to allow user 102 and/or the owner/operator of the vehicle to view the transaction.

In various embodiments, payment provider server 150 includes other applications 154 as may be desired in particular embodiments to provide features to payment provider server 150. For example, other applications 154 may include security applications for implementing server-side security features, programmatic server applications for interfacing with appropriate application programming interfaces (APIs) over network 170, or other types of applications. Other applications 154 may contain software programs, executable by a processor, including a graphical user interface (GUI), configured to provide an interface to a user.

Additionally, payment provider server 150 includes database 156. As previously discussed, user 102 and/or the owner/operator of the vehicle corresponding to vehicle device 130 may establish one or more payment accounts with payment provider server 150. User accounts in database 156 may include user information, such as name, address, birthdate, payment/funding information, additional user financial information, and/or other desired user data. User 102 and/or the owner/operator may link to their respective payment accounts through a user, and/or device identifier. Thus, when an identifier is transmitted to payment provider server 150, e.g. from user device 110 and/or vehicle device 130, a payment account belonging to user 102 and/or the owner/operator may be found. In other embodiments, user 102 and/or the owner/operator may not have previously established a payment account and may provide other financial information to payment provider server 150 to complete financial transactions, as previously discussed. Additionally, database 156 may store received information, such as parameters for users and travel costs for use of the vehicle, as well as processed information, such as pro rata shares of the travel costs for each user.

In various embodiments, payment provider server 150 includes at least one network interface component 158 adapted to communicate user device 110 and/or vehicle device 130 over network 170. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

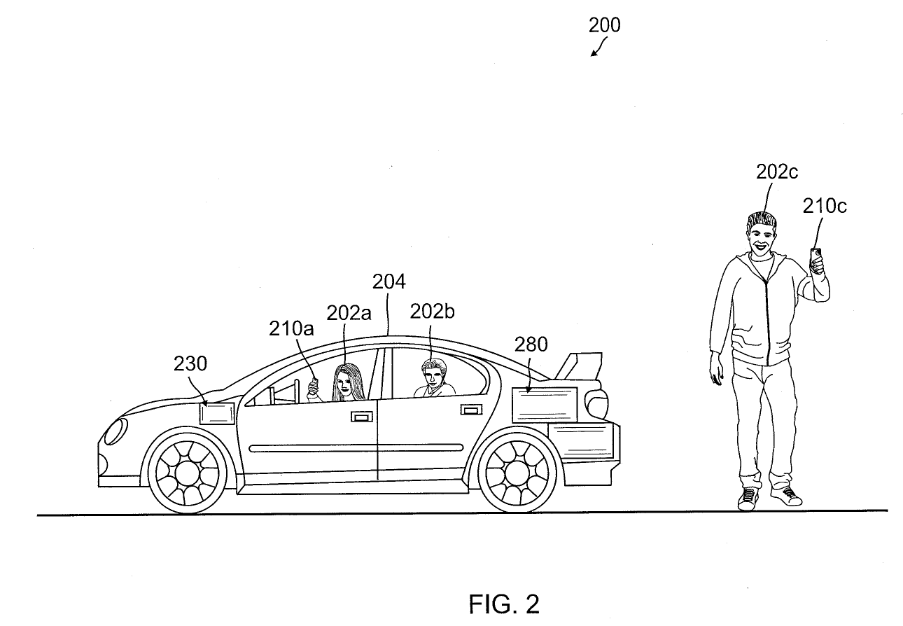

FIG. 2 is an exemplary environment showing users checked-in to a vehicle for splitting of travel costs and vehicle use, according to an embodiment. Environment 200 of FIG. 2 includes a user 202a, a user 202b, and a user 202b all corresponding generally to user 102 of FIG. 1. Moreover, environment 200 includes a user device 210a and a user device 210b both corresponding generally to user device 110 of FIG. 1. Additionally, environment 200 includes a vehicle device 230 corresponding generally to vehicle device 130 of FIG. 1.

In environment 200, a vehicle 204 is travelling a route with users 202a and 202b. Additionally, a user 202c has just been dropped off at a location after travelling in vehicle 204. Thus, users 202a, 202b, and 202c may have incurred travel costs during their usage of vehicle 204. While travelling in vehicle 204, user 202a may be checked-in to vehicle 204 through vehicle device 230. For example, user device 210a held by user 202a may connect to vehicle device 230 in order to effectuate a check-in for user 202a while inside and travelling with vehicle 230. Additionally, user 202b may be checked-in to vehicle 204. However, as user 202b does not have a user device on their person, or chooses not to utilize a user device to check-in to vehicle device 230, user 202b may perform a check-in with vehicle device 230 directly. User 202b may perform the check-in by providing information to vehicle device 230 using an input mechanism for vehicle device 230, such as a touch screen interface for vehicle device 230. Once check-in information for user 202a and 202b is received, user 202a and 202b may be associated with vehicle 204 so that their parameters and travel costs may be tracked for determining their pro rata shares of travel costs.

Additionally, user 202c was previously travelling in vehicle 204. However, as shown in environment 200, user 202c has exited vehicle 204, for example, by arriving at user 202c's destination. After exiting vehicle 204, user 202c may be checked out of vehicle 204 so that any further travel costs are not attributable to user 202c. Since user 202c has user device 210c with them, user 202c may be checked out from vehicle 204 when user device 210c disconnects from vehicle device 230. Thus, when user device 210c is no longer in range of vehicle device 230 to connect with vehicle device 230, it may be determined at user 202c has exited vehicle 230 and is no longer travelling in vehicle 230. In other embodiments, user 202c may manually check out from vehicle 204 using vehicle device 230, such as by selecting a check out option on a device interface for vehicle device 230. Similarly, user 202c may manually check out through a device interface for user device 210c.

While travelling in vehicle 204, users 202a and 202b may have various parameters associated with them that affect their pro rata share of travel costs for usage of vehicle 204. For example, users 202a and 202b may have different weights that affect an amount of fuel and/or electricity consumed by vehicle 204 while travelling a route. Moreover, vehicle 204 include luggage 280 in a trunk compartment. Luggage 280 may correspond to additional luggage user 202a and/or user 202b had to bring while travel the route. Therefore, if user 202a was required to bring luggage 280, than the additional weight may affect fuel/electrical consumption by vehicle 204. Thus, user 202a's pro rata share of the travel costs may include the fuel/electrical consumption of vehicle 204 due to luggage 280. Additionally, as previously discussed, a parameter for user 202c may correspond to the endpoint for user 202c. Thus, as user 202c exits vehicle 204 prior to the end of use of vehicle 204, user 202c may only be charged the pro rata share of travel in vehicle 204 from user 202c's start point to user 202c's endpoint, which is shorter than travelling the complete route traveled by users 202a and 202b.

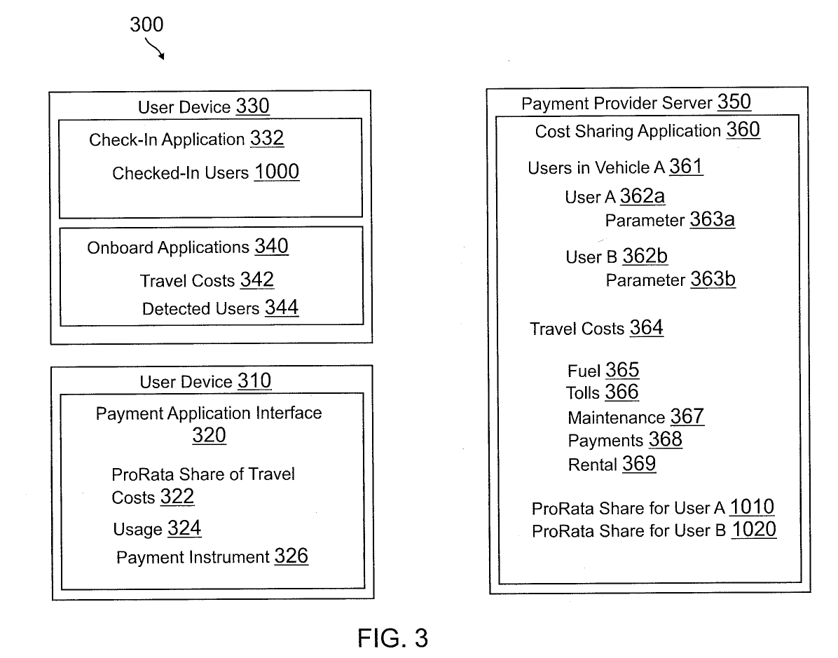

FIG. 3 is an exemplary system environment showing a vehicle system calculating travel costs owed by each traveler in a vehicle, according to an embodiment. Environment 300 includes a user device 310, a vehicle 330, and a payment provider server 350 corresponding generally to user device 110, vehicle device 130, and payment provider server 150, respectively, of FIG. 1.

Vehicle device 330 includes a check-in application 332 and on board applications 340 corresponding generally to the processes and features described in reference to check-in application 132 and on board applications 140, respectively, of FIG. 1. Check-in application 332 includes checked-in users 1000 having information identifying users checked-in to a vehicle for use in determining the users' pro rata share/portion of travel costs for use of the vehicle. On board applications 340 correspond to a set of applications for use in detecting users in the vehicle to request a check-in, determining the users' parameters, and tracking travel costs during use of the vehicle. In this regard, on board applications 340 include travel costs 340 having information about expenditures while using a vehicle, such as fuel/electricity, rental fees, maintenance, tolls, specialty requirements, and/or payments issued. On board applications 340 further include detected users 344 having information about users in the vehicle detected from one or more vehicle sensors, and may further include the users parameters, such as a traveled route, weight, and/or luggage weight. The users' parameters may be determined through the vehicle sensors, check-in/check out information, and/or received information.

Payment provider server 350 may receive information from vehicle device 330 for use in determining the pro rata share of the travel costs from on board applications 340 and/or receive costs. In this regard, payment provider server 350 includes a cost sharing application 360 corresponding generally to the processes and features described in reference to cost sharing application 160 of FIG. 1. In order to determine pro rata shares of travel costs for users in a vehicle, cost sharing application 360 processes users in vehicle A 361 and travel costs 364 to determine pro rata share for user A 1010 and pro rata share for user B 1020. Users in vehicle A 361 includes user A 362a having parameters 363a, such as weights and travel routes, and may include vehicle expenses directly attributable to user A. Similarly, user B 362b includes parameters 363b.

Travel costs 364 include fuel 365, tolls 366, maintenance 367, payments 368, and rental 369. Fuel 365 may include costs for fuel expenditures, including gas, electricity, or other fuel types, as well as battery usage. Tolls 366 include tolls incurred during travel of a route. Maintenance 367 includes vehicle maintenance required after traveling a route, and may further include specialty expenditures and maintenance, such as snow chains. Payments 368 include payments issued from vehicle device 330, such as payments for vehicle services (e.g., wireless Internet, mobile phone, etc.), payments for food/drink purchased in the vehicle, etc. Rental 369 may correspond to rental costs for the vehicle, including daily rental fees, mileage rental fees, insurance, etc. In certain embodiments where a vehicle is shared, travel costs may also include vehicle payments for purchase/lease of the vehicle, insurance, etc. Utilizing the aforementioned information with parameters 363a, a pro rata share for user A 1010 may be determined. Similarly, the aforementioned information may be utilized with parameters 363b to determine a pro rata share for user B 1020.

After determining a pro rata share for user A 1010 and a pro rata share for user B 1020, payment provider server 350 may communicate the pro rata shares to their respective users. Thus, user device 310 may be utilized to view a user's pro rata share. User device 310 displays a payment application interface 320 corresponding generally to the processes and features described in reference to payment application 120 of FIG. 1. Payment application interface 320 includes pro rata share of travels costs 322 having the information from pro rata share for user A 1010 or pro rata share for user B 1020 for the user of user device 310. Additionally, in order to view what the user is being charged for in the travel costs, payment application interface 320 includes usage 324, which may display a breakdown of the user's usage of the vehicle. The user may then issue a payment for pro rata share of travel costs 322 by selecting a payment instrument 326 and initiating a payment process using payment instrument 326.

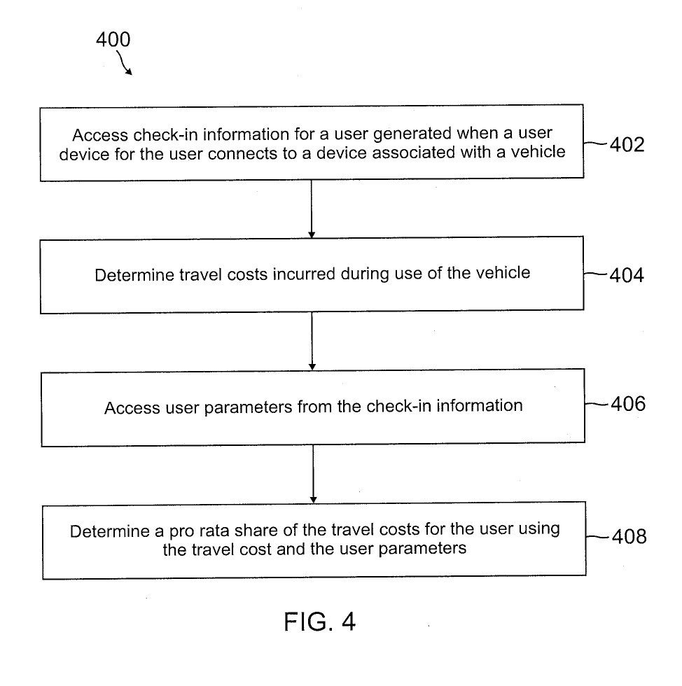

FIG. 4 is a flowchart of an exemplary process automated splitting of costs incurred during a shared vehicle travel, according to an embodiment. Note that one or more steps, processes, and methods described herein may be omitted, performed in a different sequence, or combined as desired or appropriate.

At step 402, check-in information for a user generated when a user device for the user connects to a device associated with a vehicle is accessed. The check-in information may correspond to log in information for a user account with the vehicle and/or a payment provider. The user device and the device associated with the vehicle may connect using one of near field communication, radio communication, infrared communication, Bluetooth communication, Bluetooth Low Energy (BLE) communication, and LTE Direct communication. The device associated with the vehicle may comprise one of a mobile phone, a tablet computer, a dashboard console device in the vehicle, and a processing device connected to the vehicle. In various embodiments, the device associated with the vehicle may be registered as the primary device for the vehicle, wherein a primary user of the vehicle provides log in credentials for registering the device and a payment account for use in at least one payment (e.g., for a travel cost). Thus, the log in credentials may be received to verify the primary user is utilizing the vehicle.

Additionally, prior to accessing the check-in information, it may be determined a plurality of users is located in the vehicle. For example, each of the plurality of users may be determined to be located in the vehicle using at least one of a weight sensor in a seat in the vehicle, a connection between a user device for at least one of the plurality of users and the device, a door sensor for the vehicle, and an in-vehicle camera for the vehicle. Moreover, the check-in information may be requested from each of the plurality of users, such as by logging in to the device associated with the vehicle. Each of the plurality of users may log in to the device using a biometric reading submitted by the each of the plurality of users on a sensor of the device located in at least one of a door of the vehicle, a seat of the vehicle, and a display interface of the device. In other embodiments, each of the plurality of users may log in to the device by submitting log in credentials on the device or by connecting a user device associated with each of the plurality of users to the device.

Travel costs incurred during use of the vehicle may be determined, at step 404. Travel costs may comprise at least one of fuel consumed during by the vehicle during a route traveled by the vehicle, a toll required during the route, maintenance required by the vehicle after travelling the route, electricity used by the vehicle during the route, a rental cost for the vehicle, a parking cost for the vehicle during or after the route, and purchases made by the user through the device associated with the vehicle during the route. The payment account associated with a primary user may also be used to provide a payment for the travel costs.

At step 406, user parameters are accessed from the check-in information. The user parameters may be determined and/or received when completing the check-in for a user. Thus, the user parameters may be determined from the device associated with the vehicle, for example, using sensors in the vehicle. The user parameters may comprise a weight of the user, a weight of luggage associated with the user, and a starting point for the user during a route taken in the at least one travel cost, and an end point for the user during the route taken in the at least one travel cost. A weight of the user may be determined using a weight sensor in a set of the vehicle or may be manually entered by the user. The pro rata portion of the total cost may also be communicated to a payment provider for payment by the user.

A pro rata share of the travel costs for the user is determined using the travels costs and the user parameters, at step 408. Once determined, the pro rata portion of the total cost may be communicated to a user device for the user for payment by the user.

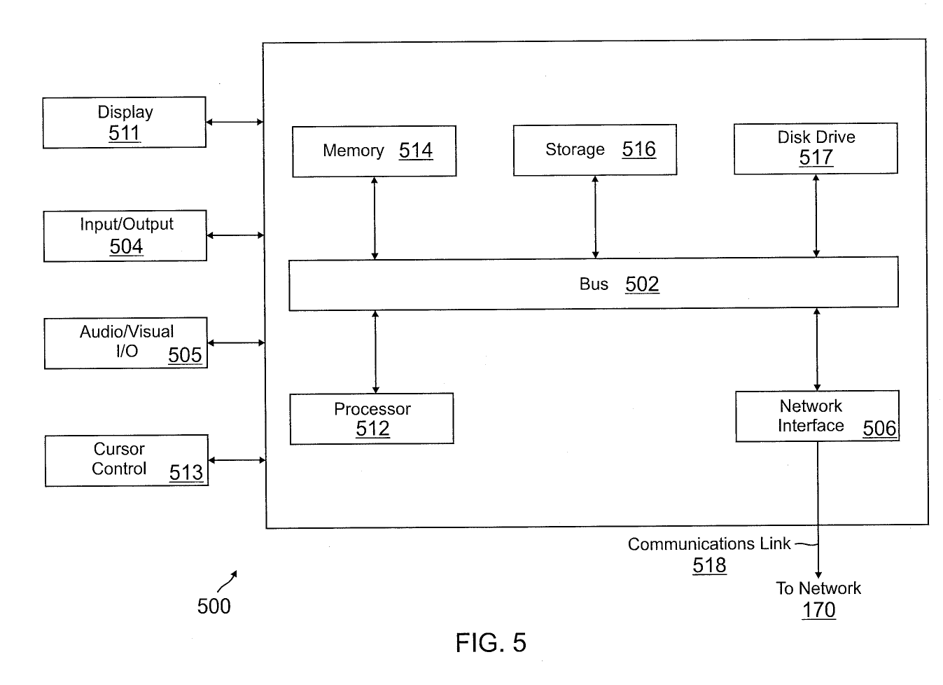

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, service device, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing check-in information for a user; and
one or more hardware processors in communication with the non-transitory memory and configured to:
access the check in information for the user generated when a user device for the user connects to a device associated with a vehicle;
determine at least one travel cost incurred during use of the vehicle;
access at least one parameter for the user from the check-in information; and
determine a pro rata share of the at least one travel cost for the user using the at least one travel cost and the at least one parameter.

2. The system of claim 1, wherein the user device and the device associated with the vehicle connect using one of near field communication, radio communication, infrared communication, Bluetooth communication, Bluetooth Low Energy (BLE) communication, and LTE Direct communication.

3. The system of claim 1, wherein the device associated with the vehicle comprises one of a mobile phone, a tablet computer, a dashboard console device in the vehicle, and a processing device connected to the vehicle.

4. The system of claim 1, wherein the at least one parameter is determined from the device associated with the vehicle.

5. The system of claim 1, wherein the at least one parameter comprises a weight of the user, a weight of luggage associated with the user, and a starting point for the user during a route taken in the at least one travel cost, and an end point for the user during the route taken in the at least one travel cost.

6. The system of claim 1, wherein the at least one travel costs comprises at least one of fuel consumed during by the vehicle during a route traveled by the vehicle, a toll required during the route, maintenance required by the vehicle after travelling the route, electricity used by the vehicle during the route, a rental cost for the vehicle, a parking cost for the vehicle during or after the route, and purchases made by the user through the device associated with the vehicle during the route.

7. The system of claim 1, wherein prior to the one or more hardware processors accessing the check-in information, the one or more hardware processors are further configured to:
register the device associated with the vehicle as the primary device for the vehicle, wherein a primary user of the vehicle provides log in credentials for registering the device and a payment account for use in at least one payment for the at least one travel cost.

8. The system of claim 7, wherein the one or more hardware processors are further configured to:
receive the log in credentials to verify that the primary user is utilizing the vehicle.

9. The system of claim 8, wherein prior to the one or more hardware processors determining the at least one travel cost, the one or more hardware processors are further configured to:
process a payment for the at least one travel cost using the payment account.

10. A method comprising:
accessing a plurality of check in information for a plurality of users generated when the each of the plurality of users log in to a device associated with a vehicle;
determining a cost for a travel route during use of the vehicle;
accessing at least one parameter for each of the plurality of users from the plurality of check-in information; and
determining, using one a or more hardware processors, a pro rata share of the cost for the each of the plurality of users using the cost and the at least one parameter.

11. The method of claim 10, wherein prior to the accessing the plurality of check-in information, the method further comprises:
determining the each of the plurality of users are located in the vehicle.

12. The method of claim 11, wherein prior to the accessing the plurality of check-in information, the method further comprises:
requesting the plurality of check-in information for each of the plurality when determining the each of the plurality of users are located in the vehicle.

13. The method of claim 11, wherein the each of the plurality of users are determined to be located in the vehicle using at least one of a weight sensor in a seat in the vehicle, a connection between a user device for at least one of the plurality of users and the device, a door sensor for the vehicle, and an in-vehicle camera for the vehicle.

14. The method of claim 10, wherein the at least one parameter comprises a weight for the each of the plurality of users, and wherein at least one weight sensors in at least one seat of the vehicle determines the weight for the each of the plurality of users.

15. The method of claim 10, wherein the each of the plurality of users log in to the device using a biometric reading submitted by the each of the plurality of users on a sensor of the device located in at least one of a door of the vehicle, a seat of the vehicle, and a display interface of the device.

16. The method of claim 10, wherein the each of the plurality of users log in to the device by submitting log in credentials on the device.

17. The method of claim 10, wherein the each of the plurality of users log in to the device by connecting a user device associated with the each of the plurality of users to the device.

18. A non-transitory computer-readable medium comprising instructions which, in response to execution by a computer system, cause the computer system to perform a method comprising:
accessing log in information for a user submitted to a device associated with a vehicle;
determining a total cost during use of the vehicle for traveling a route with the user;
determining a portion of the user of the vehicle for the user based on characteristics of the user; and
determining a pro rata portion of the total cost for the user using the total cost and the portion.

19. The non-transitory computer-readable medium of claim 18, wherein the method further comprises:
communicating the pro rata portion of the total cost to a user device for the user for payment by the user.

20. The non-transitory computer-readable medium of claim 18, wherein the method further comprises:
communicating the pro rata portion of the total cost to a payment provider for payment by the user.
